(19) United States
(12) Patent Application Publication
(10) Pub. No.: US 2015/0017427 A1
(43) Pub. Date: Jan. 15, 2015

(54) BLENDS FOR PRESSURE SENSITIVE ADHESIVES USED IN PROTECTIVE FILMS

(71) Applicant: 3M INNOVATIVE PROPERTIES COMPANY, St. Paul, MN (US)

(72) Inventors: Jingjing Ma, Cottage Grove, MN (US); Zhipeng Song, Woodbury, MN (US)

(21) Appl. No.: 14/375,591

(22) PCT Filed: Feb. 1, 2013
(86) PCT No.: PCT/US2013/024317

§ 371 Date: Jul. 30, 2014

Related U.S. Application Data
(60) Provisional application No. 61/594,473, filed on Feb. 3, 2012.

(51) Int. Cl. B32B 15/08; B32B 15/085; C09J 133/08; B32B 7/12

(52) U.S. Cl. CPC B32B 15/08; B32B 7/12; B32B 15/085; C09J 133/08; B32B 2255/10; B32B 2264/102; B32B 2274/00; B32B 2311/00; B32B 2311/30; B32B 2270/00; B32B 2323/043; B32B 2323/046
USPC 428/327; 428/465; 428/463; 428/462; 524/555

(57) ABSTRACT

There is provided an article comprising: a) a protective film comprising a thermoplastic film having a first side and a second side, and a pressure sensitive adhesive composition adhesively attached to at least one of the first side or the second side of the thermoplastic film, wherein the pressure sensitive adhesive composition comprises a blend of: i) an aqueous based pressure sensitive adhesive latex; ii) a low adhesion additive; and iii) a crosslinker; and b) a metal substrate adhesively attached to a side of the pressure sensitive adhesive composition opposite the thermoplastic film. There is also provided a pressure sensitive adhesive composition comprises a blend of: i) an aqueous based pressure sensitive adhesive latex; ii) a low adhesion additive; and iii) a cross linker.

### FIELD

This disclosure relates to blends for pressure sensitive adhesives used in protective films. This disclosure also relates to pressure sensitive adhesive compositions having a blend of an aqueous based pressure sensitive adhesive latex and a low adhesion additive selected to achieve tunable adhesion and reduced adhesion buildup during heat/humidity aging.

### BACKGROUND

Pressure sensitive adhesive compositions made of solvent-based rubber adhesive are known for metal surface protective film/tape for laser cutting applications. When used as protective films/tapes for laser cutting applications, these pressure sensitive adhesive compositions provide good adhesion to metal surfaces. However, these pressure sensitive adhesive compositions are formulated using solvents and exhibit poor weatherability.

Other types of pressure sensitive adhesive compositions are known for repositionable applications. These types of pressure sensitive adhesive compositions provide good clean removal performance. However, they are not formulated to provide strong adhesion to metal surfaces.

There is a need for pressure sensitive adhesive compositions formulated using water based emulsions where such pressure sensitive adhesive compositions provide good adhesion and gripping to metal surfaces, particularly during laser cutting processes. There is also a need for pressure sensitive adhesive compositions that do not exhibit adhesion buildup during heat/humidity aging when used on metal surfaces.

### SUMMARY

In one aspect, the present disclosure provides an article comprising: a) a protective film comprising a thermoplastic film having a first side and a second side, and a pressure sensitive adhesive composition adhesively attached to at least one of the first side or the second side of the thermoplastic film, wherein the pressure sensitive adhesive composition comprises a blend of: i) an aqueous based pressure sensitive adhesive latex; ii) a low adhesion additive; and iii) a crosslinker; and b) a metal substrate adhesively attached to a side of the pressure sensitive adhesive composition opposite the thermoplastic film. In some embodiments, the low adhesion additive is selected from at least one of a particulate dispersion and a rubber emulsion. In some embodiments, the aqueous based pressure sensitive adhesive latex comprises at least one acrylate polymer.

In some embodiments, the aqueous based pressure sensitive latex comprises a stabilizer selected from at least one of a cationic stabilizer, anionic stabilizer, a non-ionic stabilizer, and an amphoteric stabilizer. In some embodiments, the rubber emulsion comprises a (poly)isoprene latex. In some embodiments, the particulate dispersion comprises polymeric microspheres. In some embodiments, the polymeric microspheres are elastomeric.

In some embodiments, the crosslinker is a polyaziridine. In some embodiments, the thermoplastic film is a three layer polyethylene film wherein each layer comprises low density polyethylene. In some embodiments, the middle layer of the thermoplastic film comprises high density polyethylene. In some embodiments, the metal substrate is stainless steel.

In some embodiments, the pressure sensitive adhesive composition is substantially free of acrylic acid. In some embodiments, the crosslinker comprises 0.03 wt % to 0.09 wt % based on the dry weight of the aqueous based pressure sensitive adhesive latex. In some embodiments, the low adhesion additive comprises 5 wt % to 53 wt % of the total dry weight of components i) and ii).

In another aspect, the present disclosure provides a pressure sensitive adhesive composition comprising a blend of: i) an aqueous based pressure sensitive adhesive latex; ii) a low adhesion additive; and iii) a crosslinker, wherein the low adhesion additive comprises 5 wt % to 53 wt % of the total dry weight of components i) and ii). In some embodiments, the low adhesion additive is selected from at least one of a particulate dispersion and a rubber emulsion. In some embodiments, the aqueous based pressure sensitive adhesive latex comprises at least one acrylate polymer.

In some embodiments, the aqueous based pressure sensitive adhesive latex comprises a stabilizer selected from at least one of a cationic stabilizer, anionic stabilizer, a non-ionic stabilizer, and an amphoteric stabilizer. In some embodiments, the rubber emulsion comprises a (poly)isoprene latex. In some embodiments, the particulate dispersion comprises polymeric microspheres. In some embodiments, the polymeric microspheres are elastomeric.

In some embodiments, the crosslinker is a polyaziridine. In some embodiments, the thermoplastic film is a three layer polyethylene film wherein each layer comprises low density polyethylene. In some embodiments, the middle layer of the thermoplastic elastomer comprises high density polyethylene. In some embodiments, the pressure sensitive adhesive composition is substantially free of acrylic acid. In some embodiments, the crosslinker comprises 0.03 wt % to 0.09 wt % based on the dry weight of the aqueous based pressure sensitive adhesive latex.

The above summary of the present disclosure is not intended to describe each embodiment of the present invention. The details of one or more embodiments of the invention are also set forth in the description below. Other features, objects, and advantages of the invention will be apparent from the description and from the claims.

### DETAILED DESCRIPTION

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated. These are only examples of what is specifically intended, and all possible combinations of numerical values between and including the lowest value and the highest value enumerated are to be considered to be expressly stated in this application.

As used herein:

“emulsion” refers to a stable mixture of two or more immiscible liquids or at least one solid immiscible in one or more liquid where suspension is maintained by one or more surfactants, more specifically it refers to a stable mixture of the instant polymerizable monomer mixture, or resultant polymer, and water;

“latex” refers to an aqueous suspension or emulsion of a polymer, more specifically it refers to an aqueous emulsion of the instant polymer;

“aqueous” refers to compositions having a substantial amount of water, such as for example compositions having at least 5 wt % water, in some embodiments at least 10 wt % water, in some embodiments at least 15 wt % water, in some embodiments at least 20 wt % water, in some embodiments at least 25 wt % water, in some embodiments at least 30 wt % water, in some embodiments at least 35 wt % water, in some embodiments at least 40 wt % water, in some embodiments at least 45 wt % water, and in some embodiments at least 50 wt % water;

“substantially free of acrylic acid” means a composition having less than 10.1 pbw of an acid, such as acrylic acid; and

“wt %” means weight percent.

The present disclosure relates to an article comprising: (a) a protective film comprising a thermoplastic film having a first side and a second side, and a pressure sensitive adhesive composition adhesively attached to at least one of the first side or the second side of the thermoplastic film, wherein the pressure sensitive adhesive composition comprises: i) an aqueous based pressure sensitive adhesive latex; ii) a low adhesion additive; and iii) a crosslinker; and (b) a metal substrate adhesively attached to a side of the pressure sensitive adhesive composition opposite the thermoplastic film.

Thermoplastic films useful in the present disclosure include one or more polyolefins, such as polyethylene, and the amount of the polyolefin (when two or more polyolefins are included, the combined amount thereof) preferably accounts for at least 50 wt % of the entire thermoplastic film. In other words, for example, at least 50 wt % of the entire thermoplastic film is made of polyethylene. This thermoplastic film may have a single-layer structure or may have a multilayer structure of two or more layers. In order to optimize the balance between the thickness and the elastic modulus of the film, a thermoplastic film having a multilayer structure is useful.

The above polyethylene may be one or more of a variety of polymers containing ethylene as an ingredient (ethylene-based polymers). The ethylene-based polymer may be a homopolymer of ethylene or may be a polymer obtained from the copolymerization of ethylene as the primary monomer with another [alpha]-olefin (random copolymerization, block copolymerization or the like). Examples of such [alpha]-olefins include [alpha]-olefins having 3 to 10 carbon atoms such as propylene, 1-butene (may be branched 1-butene), 1-hexene, 4-methyl-1-pentene and 1-octene. Alternatively, the polyethylene resin may be a copolymer of ethylene with a monomer having both a polymerizable functional group and also another functional group (functional group-containing monomer), or a resin obtained by copolymerizing such a functional group-containing monomer with an ethylene-based polymer. Representative examples of copolymers of ethylene and functional group-containing monomers include ethylene-vinyl acetate copolymers (EVA), ethylene-acrylic acid copolymers (EAA), ethylene-methacrylic acid copolymers (EMAA), ethylene-methyl acrylate copolymers (EMA), ethylene-ethyl acrylate copolymers (EEA), ethylene-methyl methacrylate copolymers (EMMA) and ethylene-(meth)acrylic acid (i.e. acrylic acid and/or methacrylic acid) copolymers that have been crosslinked with metallic ions.

The density of the polyethylene included in the thermoplastic film, although not subject to any particular limitation, may be, for example, from about 0.89 to about 0.94 g/cm³. Preferred polyethylenes include low-density polyethylene (LDPE) (e.g., LDPE having a density of from about 0.91 to about 0.93 g/cm³) and linear low-density polyethylene LLDPE (e.g., LLDPE having a density of from about 0.89 to 0.93 g/cm³). The thermoplastic film may optionally contain one or more types of LDPE and one or more types of LLDPE, either as a blend or separately (e.g., as the materials forming mutually differing layers in a thermoplastic film having a multilayer structure). The ratio between the amounts in which these respective polyethylenes are used (blending ratio), although not subject to any particular limitation, may be suitably selected so as to provide a thermoplastic film having the desired properties.

The thermoplastic film may also include, as needed, suitable ingredients for which inclusion in the substrate is allowed. For example, additives such as pigments (typically, inorganic pigments such as white pigments), fillers, antioxidants, light stabilizers (in a sense that is inclusive of radical scavengers and ultraviolet absorbers), slip agents, and anti-blocking agents may be suitably admixed. Examples of materials that may be suitably used as pigments or fillers include inorganic powders such as titanium oxide, zinc oxide and calcium carbonate. For example, advantageous use may be made of a highly weather-resistant type titanium oxide (typically, rutile-type titanium dioxide) coated on the particle surfaces with, for example, SiO2/Al2O3. The amount of inorganic pigment and filler may be suitably selected while taking into consideration the extent of the effects obtained by such inclusion and the required moldability that is dependent on the resin sheet-forming process (e.g., T-die extrusion, blown-film extrusion). Generally speaking, it is preferable to set the amount of inorganic pigment and filler (in cases in which a plurality of types are included, the combined amount thereof) to from about 2 to about 20 parts by weight (e.g., from 4 to 20 parts by weight, and more preferably from 5 to 15 parts by weight) per 100 parts by weight of the resin component. The amount of the respective ingredients (additives) may be set to about the same level as the normal amount in the field of resin sheets used, for example, as thermoplastic film in protective films. In a thermoplastic film having a multilayer structure, the type and concentration of the additives included in the respective layers may be the same or different.

Pressure sensitive adhesives useful in the present disclosure include an aqueous based pressure sensitive adhesive latex (also referred to herein as “the latex”), a low adhesion additive, and a crosslinker. Aqueous based pressure sensitive adhesive latexes useful in the present disclosure include water-based acrylic pressure sensitive adhesives. Exemplary water-based acrylic pressure sensitive adhesives include latexes comprising:

a) 30 to about 70 wt %, based on the total weight of the aqueous based pressure sensitive adhesive latex, of a polymer phase comprising the reaction product of:
(i) 90 to 99 parts by weight, preferably 90 to 95 parts be weight, of an (meth)acrylic acid ester of non-tertiary alcohol, said alcohol having from 1 to 14 carbon atoms, with the average number of carbon atoms being from about 4 to about 12;
(ii) 1 to 10 parts by weight, preferably 2 to 7 parts by weight, of an acid functional monomer;
(iii) 0 to 10 parts by weight of a second, non-acid functional, polar monomer;
(iv) 0 to 5 parts by weight of vinyl monomer;
(v) 0 to 0.5 parts by weight of a chain transfer agent; and wherein the sum of (i) through (v) is 100 parts by weight, and

(b) 70 to 30 wt % of an aqueous phase comprising 0.5 to about 8 wt % of a surfactant, preferably an anionic surfactant, based on the total weight of the latex.

In some embodiments the latex comprises about 50 to about 65 wt % polymer and about 35 to about 50 wt % aqueous phase, and in some embodiments about 55 to about 62 wt % solid phase and about 38 to about 45 wt % aqueous phase, based upon the total weight of the aqueous emulsion, in order to minimize the aqueous phase and thus conserve energy during the drying of the latex, in order to minimize storage and shipping costs, and in order to maximize plant productivity. The polymer component of the latex may comprise one or more polymers.

The acrylate ester monomer useful in preparing the polymer in the latex is a hydrophobic monomeric (meth)acrylic ester of a non-tertiary alcohol, which alcohol contains from 1 to 14 carbon atoms, and preferably an average of from 4 to 12 carbon atoms.

Examples of monomers suitable for use as the acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctyl alcohol, 2-ethyl-1hexanol, 1-decanol, 1-dodecanol, 1-tridecanol, 1-tetradecanol and the like. In some embodiments, the preferred acrylate ester monomer is the ester of acrylic acid with butyl alcohol or isooctyl alcohol, or a combination thereof, although combinations of two or more different acrylate ester monomer are suitable.

In some embodiments, the acrylate ester monomer is present in an amount of 90 to 99 parts by weight based on 100 parts total monomer content used to prepare the polymer (i.e. the total of i through v in the composition supra). In some embodiments, acrylate ester monomer is present in an amount of 90 to 95 parts by weight based.

The polymer further comprises an acid functional monomer, where the acid functional group may be an acid per se, such as a carboxylic acid, or a salt thereof such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, (3-carboxyethyl acrylate, 2-sulfoethyl methacrylate, styrene sulfonic acid, 2-acrylamido-2-methylpropanesulfonic acid, vinylphosphonic acid, and mixtures thereof.

The acid functional monomer is generally used in amounts of 1 to 10 parts by weight, preferably 1 to 5 parts by weight, based on 100 parts by weight total monomer.

The polar monomers useful in preparing the adhesive polymer are both somewhat oil soluble and water soluble, resulting in a distribution of the polar monomer between the aqueous and oil phases in an emulsion polymerization. Useful second polar monomers are non-acid functional.

Representative examples of suitable polar monomers include but are not limited to 2-hydroxylethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl)acrylates including 2-(2-ethoxyethoxy)ethyl acrylate, 2-ethoxyethyl acrylate, 2-methoxyethoxyethyl acrylate, 2-methoxyethyl methacrylate, polyethylene glycol mono(meth)acrylates; alkyl vinyl ethers, including vinyl methyl ether; and mixtures thereof. In some embodiments, polar monomers include those selected from the group consisting of 2-hydroxyethyl (meth)acrylate and N-vinylpyrrolidone.

When used, vinyl monomers useful in the acrylate adhesive polymer include vinyl esters (e.g., vinyl acetate and vinyl propionate), styrene, substituted styrene (e.g., a-methyl styrene), vinyl halide, and mixtures thereof. Such vinyl monomers are generally used at 0 to 5 parts by weight, preferably 1 to 5 parts by weight, based on 100 parts by weight total monomer.

In some embodiments, a crosslinking additive may be incorporated into the blend or polymerizable monomers. Crosslinking may also be achieved using high energy electromagnetic radiation such as gamma, UV or e-beam radiation.

Multi-functional acrylates are particularly useful for emulsion polymerization. Examples of useful multifunctional acrylate crosslinking agents include, but are not limited to, diacrylates, triacrylates, and tetraacrylates, such as 1,6-hexanediol diacrylate, poly(ethylene glycol) diacrylates, polybutadiene diacrylate, polyurethane diacrylates, and propoxylated glycerin triacrylate, and mixtures thereof.

Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyldimethylethoxysilane, vinylmethyldiethoxysilane, vinyltriethoxysilane, vinyltrimethoxysilane, vinyltriphenoxysilane, and the like, are also useful crosslinking agents.

The amount and type of crosslinker is tailored depending upon application of the aqueous based pressure sensitive adhesive latex. Typically, the crosslinker is present in amounts less than 5 parts based on total dry weight of adhesive composition. More specifically, the crosslinker is present in amounts from 0.01 parts to 1 part based on 100 parts total monomers of the adhesive composition.

Other additives can be added in order to enhance the performance of the adhesive compositions. For example, leveling agents, oxygen inhibitors, rheology modifiers, wetting agents, defoamers, biocides, dyes and the like, can be included herein. All of these additives and the use thereof are well known in the art. It is understood that any of these compounds can be used so long as they do not deleteriously affect the adhesive properties.

Also useful as additives to the present compositions are UV absorbers and hindered amine light stabilizers. UV absorbers and hindered amine light stabilizers act to diminish the harmful effects of UV radiation on the final cured product and thereby enhance the weatherability, or resistance to cracking, yellowing and delamination of the coating. Exemplary concentrations of UV absorbers include those in the range of 1 to 5 percent based on the total weight of the composition.

The polymers herein can be prepared by any conventional free radical polymerization method, including dispersion, emulsion, and suspension processes. The acrylate polymers may be prepared via suspension polymerizations as disclosed in U.S. Pat. No. 3,691,140 (Silver); U.S. Pat. No. 4,166,152 (Baker et al.); U.S. Pat. No. 4,636,432 (Shibano et al.); U.S. Pat. No. 4,656,218 (Kinoshita); and U.S. Pat. No. 5,045,569 (Delgado). Each describes adhesive compositions, and the descriptions of polymerization processes are incorporated herein by reference. In some embodiments, the acrylate polymer is prepared by an emulsion polymerization process in the presence of a free-radical initiator.

Water-soluble and oil-soluble initiators useful in preparing the acrylate adhesive polymers used in the present disclosure are initiators that, on exposure to heat, generate free-radicals which initiate (co)polymerization of the monomer mixture. Water-soluble initiators are preferred for preparing the acrylate polymers by emulsion polymerization. Suitable water-soluble initiators include but are not limited to those selected from the group consisting of potassium persulfate, ammonium persulfate, sodium persulfate, and mixtures thereof, oxidation-reduction initiators such as the reaction product of the above-mentioned persulfates and reducing agents such as those selected from the group 4,4′-azobis(4-cyanopentanoic acid) and its soluble salts (e.g., sodium, potassium). Suitable oil-soluble initiators include but are not limited to those selected from the group consisting of azo compounds such as those available under the trade designations “VAZO 64” (2,2′-azobis(isobutyronitrile)) and “VAZO 52” (2,2′-azobis(2,4-dimethylpentanenitrile)), from E.I. du Pont de Nemours Co., peroxides such as benzoyl peroxide and lauroyl peroxide, and mixtures thereof. When used, initiators may comprise from about 0.05 to about 1 part by weight, preferably about 0.1 to about 0.5 part by weight based on 100 parts by weight of monomer components in the pressure-sensitive adhesive.

The copolymerizable emulsion mixture may optionally further comprise chain transfer agents to control the molecular weight of the resultant polymer. Examples of useful chain transfer agents include but are not limited to those selected from the group consisting of carbon tetrabromide, alcohols, mercaptans, and mixtures thereof. When present, the preferred chain transfer agents are isooctyl thioglycolate and carbon tetrabromide. The emulsion mixture may further comprise up to about 0.5 parts by weight of a chain transfer agent, typically about 0.01 to about 0.5 parts by weight, if used, preferably about 0.05 parts by weight to about 0.2 parts by weight, based upon 100 parts by weight of the total monomer mixture.

Polymerization via emulsion techniques may require the presence of an emulsifier (which may also be called an emulsifying agent or a surfactant). Useful emulsifiers for the present disclosure include those selected from the group consisting of anionic surfactants, cationic surfactants, nonionic surfactants, and mixtures thereof.

Useful anionic surfactants include but are not limited to those whose molecular structure includes at least one hydrophobic moiety selected from the group consisting of from about C6- to C12-alkyl, alkylaryl, and/or alkenyl groups as well as at least one anionic group selected from sulfate, sulfonate, phosphate, polyoxyethylene sulfate, polyoxyethylene sulfonate, polyoxyethylene phosphate, and the like, and the salts of such anionic groups, wherein said salts are selected from the group consisting of alkali metal salts, ammonium salts, tertiary amino salts, and the like. Representative commercial examples of useful anionic surfactants include sodium lauryl sulfate, available from Stepan Chemical Co. under the trade designation “POLYSTEP B-3”; sodium lauryl ether sulfate, available from Stepan Chemical Co. under the trade designation “POLYSTEP B-12”; and sodium dodecylbenzenesulfonate, available from Rhone-Poulenc under the trade designation “SIPONATE DS-10”.

Useful nonionic surfactants include but are not limited to those whose molecular structure comprises a condensation product of an organic aliphatic or alkyl aromatic hydrophobic moiety with a hydrophilic alkylene oxide such as ethylene oxide. The HLB (Hydrophilic-Lipophilic Balance) of useful nonionic surfactants is about 10 or greater, and in some embodiments from about 10 to about 20. The HLB of a surfactant is an expression of the balance of the size and strength of the hydrophilic (water-loving or polar) groups and the lipophilic (oil-loving or non-polar) groups of the surfactant. Commercial examples of nonionic surfactants useful in the present invention include but are not limited to nonylphenoxy or octylphenoxy poly(ethyleneoxy)ethanols available from Rhone-Poulenc under the trade designations “IGEPAL CA” and “IGEPAL CO” series, respectively; C11-C15 secondary-alcohol ethoxylates available from Union Carbide under the trade designation “TERGITOL 15-5” series; and polyoxyethylene sorbitan fatty acid esters available from ICI Chemicals under the trade designation “TWEEN” series of surfactants. In some embodiments, nonionic surfactants can be used in combination with cationic surfactants or anionic surfactants.

Useful cationic surfactants include alkylammonium salts having the formula CₙH₂ₙ₊₁N⁺(CH₃), where X is OH, Cl, Br, HSO₄ or a combination thereof, and where n is an integer from 8 to 22, and the formula CₙH₂ₙ₊₁N⁺₃X⁻(C₂H₅)₃X⁻, where n is an integer from 12 to 18; Gemini surfactants, for example those having the formula: [C₁₆H₃₃N⁺(CH₃)₂CₘH₂₊₁]X⁻, wherein m is an integer from 2 to 12 and X is as above; aralkylammonium salts such as, for example, benzalkonium salts; and cetylethylpiperidinium salts, for example, C₁₆H₃₃N⁺(C₂H₅)(C₅H₁₀)X⁻, wherein X is as defined above.

Alternatively, the surfactant may be an ionic surfactant copolymerizable with the monomer mixtures, and is incorporated into the polymer chain during polymerization. Examples of useful copolymerizable ionic surfactants include but are not limited to those described in WO 89/12618 (Tang et al.). The surfactants described therein have a hydrophobic portion containing alpha,beta-ethylenic unsaturation, a hydrophilic portion containing a poly(alkyleneoxy) segment, and an ionic segment.

According to WO 89/12618, the reactive surfactants arise from successive condensation polymerizations of an ethylenically-unsaturated alcohol with a prescribed amount of a first cyclic ether, e.g., propylene oxide, butylenes oxide or a mixture thereof, followed by condensation with a prescribed amount of ethylene oxide. Cationic or anionic end-group functionality is added via the terminal hydroxyl group, as desired.

The ionic copolymerizable surfactant has at least one group, preferably one group, capable of reacting with the copolymerizable monomer mixture. Such reactive groups include but are not limited to those groups selected from the group consisting of ethylenically unsaturated groups such as vinyl groups, acrylate groups, etc.

An exemplary copolymerizable surfactant is commercially available under the trade designation “MAZON SAM-211” from PPG Industries, Inc. and is described as an alkylene polyalkoxy ammonium sulfate, wherein the number of alkoxy groups is between about 5 and about 25, with a typical example having about 15 to about 20 ethoxy groups. Examples of additional useful copolymerizable surfactants include alkyl allyl sulfosuccinates such as that commercially available under the trade designation “TREM-LF40” from Diamond Shamrock Company. Additional useful copolymerizable surfactants are disclosed in U.S. Pat. Nos. 3,925,442 and 3,983,166, assigned to The Kendall Company, both incorporated by reference herein.

It is also envisioned that the aqueous based pressure sensitive latex of the present disclosure can be made using a mixture of a copolymerizable surfactant as delineated above and a typical ionic or nonionic noncopolymerizable surfactant commonly known in the art of emulsion polymerization, in place of the ionic copolymerizable surfactant above. Examples of such noncopolymerizable surfactants can be found in “Emulsion Polymerization: theory and practice”, by D. C. Blackley, N.Y., J. Wiley (1975), incorporated by reference herein. In some embodiments, the surfactant mixture comprises about 40 to about 99.5 wt % of an ionic copolymerizable surfactant and about 0.5 to about 60 wt % of a noncopolymerizable surfactant, based upon the total weight of the surfactant mixture.

In some embodiments, emulsion polymerization of the presently disclosed aqueous based pressure sensitive adhesive latex is carried out in the presence of anionic surfactant(s). A useful range of emulsifier concentration is from about 0.5 to about 8 wt %, preferably from about 1 to about 5 wt %, based on the total weight of all monomers of the emulsion pressure-sensitive adhesive.

The presently disclosed aqueous based pressure sensitive adhesive latex may also contain one or more conventional additives. Exemplary additives include tackifiers, plasticizers, dyes, antioxidants, and UV stabilizers.

Additional disclosure on methods for making the presently disclosed aqueous based pressure sensitive adhesive latex are included in U.S. Pat. Publ. No. 2007/0213448 A1 (Lewandowski et al.), which is hereby incorporated by reference in its entirety.

Low adhesion additives useful in the present disclosure include acrylic emulsion, particulate dispersions and rubber emulsions. The phrase “low adhesion” as used herein means additives having a tack less than the aqueous based pressure sensitive latex component in the pressure sensitive adhesive composition. Low adhesion additives comprise between 5 wt % and 53 wt % of the pressure sensitive adhesive composition, where the wt % is based on the total dry weight of low adhesion additive and aqueous based pressure sensitive latex.

Exemplary acrylic emulsions useful in the present disclosure include those available under the trade designation “CARBOTAC 26222” commercially available from The Lubrizol Corporation, Ohio, USA. Exemplary high solids acrylic polymer useful in the present disclosure include those available under the trade designation “SYNTHEBOND E2075” from Momentive Specialty Chemicals, Inc., South Carolina, USA.

Exemplary particulate dispersions useful in the present disclosure include microsphere adhesives. Microsphere adhesives useful in the present disclosure should comprise at least one alkyl (meth)acrylate ester. Alkyl (meth)acrylate monomers useful in preparing the solid tacky microspheres for pressure-sensitive adhesives are mono unsaturated (meth)acrylate esters of non-tertiary alkyl alcohols, the alkyl groups having from 4 to 14 carbon atoms. Such acrylates are oleophilic, water emulsifiable, and have restricted water solubility. As homopolymers, they generally have a glass transition temperature below about −20° C. Included within this class of monomers are, for example, isooctyl acrylate, 4-methyl-2-pentyl acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate and combinations thereof.

(Meth)acrylate or other vinyl monomers which, as homopolymers, have glass transition temperatures higher than about −20° C., e.g., tert-butyl acrylate, isobornyl acrylate, butyl methacrylate, vinyl acetate, N-vinylpyrolidone, acrylamide, and the like, may be used in conjunction with one or more of the (meth)acrylate monomers, provided that the glass transition temperature of the resultant polymer is below −20° C.

Microsphere adhesives useful in some embodiments are described in U.S. Pat. No. 3,691,140 (Silver et al.); U.S. Pat. No. 5,714,237 (Corrider et al.); and U.S. Pat. No. 5,824,748 (Kesti et al.), all of which are incorporated by reference. These microsphere adhesives use at least one monomer selected from the group consisting of substantially oil-insoluble, water soluble, ionic monomers and maleic anhydride. The monomers can be used alone, as a mixture of two or more ionic monomers or as a mixture of maleic anhydride and one or more ionic monomers.

Microsphere adhesives can be prepared by an aqueous suspension polymerization technique using surfactants in an amount greater than the critical micelle concentration. Critical micelle concentration is defined as that minimum surfactants concentration necessary for the formation of micelles. The critical micelle concentration is slightly different for each surfactant. Useable concentrations typically range from 1.0×10⁻⁴ to 3.0×10° moles per liter. Anionic, nonionic or cationic surfactants can be used. Typical examples of anionic surfactants include sodium dodecylbenzenesulfonate, sodium salts of alkyl aryl ether sulfonates and the like. Examples of nonionic surfactants include ethoxylated oleyl alcohol and polyoxyethylene octylphenyl ether. An example of cationic surfactants is a mixture of alkyldimethylbenzylammonium chloride, where the alkyl chain is from ten to eighteen carbons long. While only examples of anionic, nonionic and cationic surfactants are given herein, it is believed that amphoteric surfactants would likewise work.

Initiators effecting polymerization are those which are normally suitable for free-radical polymerization of acrylate monomers. Non-limiting examples of such initiators include thermally-activated initiators such as azo compounds, hydroperoxides, peroxides and the like and photoinitiators such as benzophenone, benzoin ethyl ether, and 2,2-dimethoxy-2-phenylacetophenone. Other suitable initiators include lauryl peroxide and bis(t-butylcyclohexyl)peroxydicarbonate. The initiator concentration should be sufficient to bring about a substantially complete monomer conversion in a desired time span and temperature range. Parameters that affect the concentration of initiator used include the type of initiator and particular monomer(s) involved. It is believed that effective concentrations range from 0.10 to 1 percent, preferably from 0.25 to 0.70 wt % of the total monomers. Polymeric stabilizers may also be used, if desired. Heat or radiation can be applied to initiate the polymerization of the monomers, which is an exothermic reaction.

The microsphere adhesives may also contain a crosslinking agent. Examples of useful crosslinking agents include, but are not limited to: multifunctional (meth)acrylate(s), e.g., butanediol diacrylate or hexanediol diacrylate or other multifunctional crosslinkers such as divinylbenzene, and mixtures thereof.

When used, crosslinker(s) is (are) added at a level of up to 0.15 equivalent wt %, and in some embodiments up to 0.1 equivalent wt %, of the total polymerizable composition. The “equivalent wt %” of a given compound is defined as the number of equivalents of that compound divided by the number of equivalents in the total composition, wherein the equivalent is the number of grams divided by the equivalent weight.

Following polymerization, a stable aqueous suspension of solid microspheres at room temperature is obtained. The suspension may have non-volatile solids contents from 10 wt % to 65 wt %. The aqueous suspension of microspheres may be used immediately following polymerization, if desired. Upon prolonged standing, the suspension separates into two phases, one being aqueous and the other being an aqueous suspension of the polymeric microsphere. The microsphere-rich phase can be isolated, and provide an aqueous suspension having a non-volatile solids content, which if shaken, will readily redisperse.

In some embodiments, the presently disclosed microsphere adhesives include a binder, such as a latex binder. Suitable commercially available latex binder has pressure sensitive adhesive properties. An exemplary latex binder is commercially available under the trade designation “CARBOTAC 26222” from Lubrizol Corporation, Brecksville, Ohio.

In some embodiments, the presently disclosed microsphere adhesives include at least one polymeric suspension stabilizer. Suitable polymeric suspension stabilizers include synthetic water-soluble polymers and cellulose derivatives, which are used in the micro-suspension polymerization. Exemplary polymeric suspension stabilizers are those selected from the group consisting of polyacrylamide, polyacrylic acid, polyvinylpyrrolidone, and combinations thereof. An exemplary polymeric suspension stabilizer is the polyacrylamide commercially available under the trade designation “CYANAMER N-300” from Kemira Water Solutions, Incorporated, Bartow, Fla.

Rubber emulsions useful in the present disclosure include water-based emulsions of an anionically polymerised polyisoprene with a high cis-1,4 content, such as rubber emulsions commercially available under the trade designation “IR0401” from Kraton Polymers LLC, Houston, Tex.

The presently disclosed pressure sensitive adhesive compositions include a crosslinker. Generally, any suitable crosslinking agent may be used. Exemplary crosslinking agents include covalent crosslinkers such as bisamides, epoxies, isocyanates, aziridine, oxazoline, azetidine, and melamines; ionic crosslinking agents such as multi-functional amines, metal oxides, multi-valence metal ions, and organo-metallic chelating agents (e.g., aluminum acetylacetonate); and inorganic nanoparticles (e.g., colloidal silica nanoparticles). The amount of crosslinking agent included depends on well-understood factors such as the desired degree of crosslinking and the relative effectiveness of the crosslinking agent in the particular system. Crosslinkers useful in the present disclosure include polyaziridines, such as propylene imine tri-functional polyaziridine commercially available under the trade designation “PZ-28” from Polyaziridine, LLC, Medford, N.J. The amount and type of crosslinker is tailored depending upon application of the pressure sensitive adhesive composition. Typically, the crosslinker is present in amounts less than 5 parts based on total dry weight of pressure sensitive adhesive composition.

The presently disclosed protective film is useful for a variety of surface protection applications. For example, protection of metal surfaces in laser cutting applications is one useful application for the presently disclosed protective film. Metal surfaces include a variety of metals, such as stainless steel, including dry polished stainless steel surfaces and bright annealed stainless steel surfaces. Protective films useful for protection of metal surfaces in laser cutting applications should provide sufficient adhesion during the laser cutting process while being easily and cleanly removed or repositioned without staining the surface of the metal being protected. In some embodiments, useful protective films include a pressure sensitive adhesive composition having 5 wt % to 53 wt % of a low adhesion additive, such as for example a particulate dispersion or a rubber emulsion, where the wt % is based on the total dry weight of additive and an aqueous based pressure sensitive adhesive latex in the pressure sensitive adhesive composition.

Following are exemplary embodiments and combinations of embodiments for the present disclosure:

1. An article comprising:
a) a protective film comprising a thermoplastic film having a first side and a second side, and a pressure sensitive adhesive composition adhesively attached to at least one of the first side or the second side of the thermoplastic film, wherein the pressure sensitive adhesive composition comprises a blend of:
   i) an aqueous based pressure sensitive adhesive latex;
   ii) a low adhesion additive; and
   iii) a crosslinker; and
b) a metal substrate adhesively attached to a side of the pressure sensitive adhesive composition opposite the thermoplastic film.
   2. The article of embodiment 1 wherein the low adhesion additive is selected from at least one of a particulate dispersion and a rubber emulsion.
   3. The article of embodiment 1 or 2 wherein the aqueous based pressure sensitive adhesive latex comprises at least one acrylate polymer.
   4. The article of any of the preceding embodiments wherein the aqueous based pressure sensitive latex comprises a stabilizer selected from at least one of a cationic stabilizer, anionic stabilizer, a non-ionic stabilizer, and an amphoteric stabilizer.
   5. The article of any of embodiments 2 to 4 wherein the rubber emulsion comprises a (poly)isoprene latex.
   6. The article of any of any of embodiments 2 to 4 wherein the particulate dispersion comprises polymeric microspheres.
   7. The article of embodiment 6 wherein the polymeric microspheres are elastomeric.
   8. The article of any of the preceding embodiments wherein the crosslinker is a polyaziridine.
   9. The article of any of the preceding embodiments wherein the thermoplastic film is a three layer polyethylene film wherein each layer comprises low density polyethylene.
   10. The of article of embodiment 9 wherein the middle layer comprises high density polyethylene.
   11. The article of the any of the preceding embodiments wherein the metal substrate is stainless steel.
   12. The article of the any of the preceding embodiments wherein the pressure sensitive adhesive composition is substantially free of acrylic acid.
   13. The article of the any of the preceding embodiments wherein the crosslinker comprises 0.03 wt % to 0.09 wt % based on the dry weight of the aqueous based pressure sensitive adhesive latex.
   14. The article of any of the preceding embodiments wherein the low adhesion additive comprises 5 wt % to 53 wt % of the total dry weight of components i) and ii).
   15. A pressure sensitive adhesive composition comprising a blend of:
i) an aqueous based pressure sensitive adhesive latex;
ii) a low adhesion additive; and
iii) a crosslinker,
wherein the low adhesion additive comprises 5 wt % to 53 wt % of the total dry weight of components i) and ii).
   16. The composition of embodiment 15 wherein the low adhesion additive is selected from at least one of a particulate dispersion and a rubber emulsion.
   17. The composition of embodiment 16 wherein the aqueous based pressure sensitive adhesive latex comprises at least one acrylate polymer.
   18. The composition of any of embodiments 15 to 17 wherein the aqueous based pressure sensitive adhesive latex comprises a stabilizer selected from at least one of a cationic stabilizer, anionic stabilizer, a non-ionic stabilizer, and an amphoteric stabilizer.
   19. The composition of any of embodiments 16 to 18 wherein the rubber emulsion comprises a (poly)isoprene latex.
   20. The composition of any of embodiments 16 to 18 wherein the particulate dispersion comprises polymeric microspheres.
   21. The composition of embodiment 20 wherein the polymeric microspheres are elastomeric.
   22. The composition of any of embodiments 15 to 21 wherein the crosslinker is a polyaziridine.
   23. The composition of any of embodiments 15 to 22 wherein the thermoplastic film is a three layer polyethylene film wherein each layer comprises low density polyethylene.
   24. The composition of embodiment 23 wherein the middle layer comprises high density polyethylene.
   25. The composition of the any of embodiments 15 to 24 wherein the pressure sensitive adhesive composition is substantially free of acrylic acid.
   26. The composition of the any of embodiments 15 to 25 wherein the crosslinker comprises 0.03 wt % to 0.09 wt % based on the dry weight of the aqueous based pressure sensitive adhesive latex.

Various modifications and alterations of this invention will become apparent to those skilled in the art without departing from the scope and spirit of this invention.

### Materials

| Designation | Description | Source |
|---|---|---|
| FB49 | FASTBOND 49; a water-based | 3M Company, |
| | acrylic pressure sensitive | St. Paul, MN |
| | adhesive, ca. 56% solids by | |
| | weight. | |
| MSA | A pressure sensitive adhesive, | Made using the process |
| | provided as an aqueous | described in Example 1 |
| | dispersion, ca. 61% solids by | of U.S. Pat. No. |
| | weight. | 8,030,395 as |
| | | described below. |
| IR401 | KRATON IR0401; a water- | Kraton Polymers LLC, |
| | based emulsion of an | Houston, TX |
| | anionically polymerised | |
| | polyisoprene with a high cis-1,4 | |
| | content (typically ca. 90%), ca. | |
| | 63% solids by weight. | |
| PZ | PZ-28 (a propylene imine tri- | Polyaziridine, LLC, |
| | functional polyaziridine) was | Medford, NJ |
| | obtained commercially and used | |
| | to prepare an aqueous solution | |
| | of crosslinker having a solids | |
| | level of 2 to 5% by weight. | |
| 304 P | A panel of stainless steel Type | Main Steel, |
| | 304, 20 gauge (0.038 inch, 0.96 | Chicago, IL |
| | mm), #3 finished, dry polished. | |
| 304 A | A panel of stainless steel Type | ChemInstruments, |
| | 304 as described in ASTM | Incorporated, |
| | Specification A666, 18 gauge | Fairfield, OH |
| | (0.046 inch, 1.17 mm) thick, | |
| | and having a bright annealed | |
| | finish | |
| Nitto H3 | LASERGUARD 3100H3 Light, | Nitto Denko America, |
| | a surface protection tape having | Incorporated, |
| | a blended polyethylene carrier | Fremont, CA |
| | and a high adhesion, modified | |
| | rubber based pressure sensitive | |
| | adhesive. | |
| Nitto H5 | LASERGUARD 3100H5 Blue, | Nitto Denko America, |
| | a surface protection tape having | Incorporated, |
| | a blended polyethylene carrier | Fremont, CA |
| | and a very high adhesion, | |
| | modified rubber based pressure | |
| | sensitive adhesive. | |

### Test Methods

### 180 Degree Angle Peel Adhesion.

Peel adhesion testing was performed as described in the ASTM International standard, D3330, Method A, with a 1.3 cm×20 cm (½ in.×8 in.) protective film specimen using an IMASS SP-200 slip/peel tester available from IMASS, Inc., Accord, Mass. The peel length was 3 inches (7.62 cm) and peel speed was 12 inches per minute (30.5 cm/min.). Stainless steel substrates were cleaned by wiping them, in order, with acetone, then heptane, and again with acetone. The protective film specimens were then applied to metal substrates using a nip roller to provide test panels. Peel tests were performed on the test panels after one of two aging conditions: 1) 1 hour at room temperature and 2) 48 hours at 150° F./80% relative humidity (RH). Duplicates were run for each protective film specimen. The average peel adhesion force required to remove the tape from the metal substrate was measured in ounces/0.5 inch, and normalized to 1 inch width. The results are reported in both ounces/inch (oz/in) and Newtons/decimeter (N/dm). The residue and stain after the protective film specimen was peeled off were also recorded based on ratings shown in the tables below.

| | Rating |
|---|---|
| Stain | |
| None | 0 |
| Faint | 1 |
| Ghosting | 2 |
| Heavy Ghosting | 3 |
| Residue | |
| None | 0 |
| Stringing | 1 |
| <5% Spot Transfer | 2 |
| 6-25% Transfer | 3 |
| 26-50% Transfer | 4 |
| 51-75% Transfer | 5 |
| >75% Transfer | 6 |

### Laser Cutting Performance.

Protective film samples were evaluated for laser cutting performance by first laminating by hand protective film specimens to 304 P stainless steel sheets using a rubber roller, and allowing the test samples to dwell for at least 72 hours. The test samples were then subjected to laser cutting with a Mitsubishi CO2 laser (Model ML3015LVPlus2, MC Machinery Systems, Incorporated (a company of Mitsubishi Corporation), Wood Dale, Ill.) using the settings shown below.

| | | | | Pierce | N2 | | Nozzle | Focus |
|---|---|---|---|---|---|---|---|---|
| Process | | | | time | Pressure | Feed Rate | Gap | Length |
| Step | Watts | Hz | % Duty | (sec) | (MPa) | (cm/min) | (mm) | (mm) |
| Pierce | 400 | 20 | 15 | 0.1 | various | NA | 2.03 | 1.27 |
| Cut | 1000 | 600 | 40 | NA | 0.8 | 203 | 2.03 | 0 |

NA: not applicable

The pierce pressure was varied as given in Table 9 below. If a “blow-up” occurred (the film blew off the metal substrate during either the piercing or cutting step), the test sample was assigned a rating of “F” indicating the sample failed the test. If no blow-up occurred, the test sample was assigned a rating of “P” indicating the sample passed the test.

### Examples

### MSA Preparation

A monomer solution was made/mixing the following components in a 1000 mL container equipped with a magnetic stirrer until a homogeneous solution was obtained: 23.75 g octyl acrylamide (National Starch and Chemical Company, Bridgewater, N.J.); 1.50 g of 1,6-hexanediol diacrylate (Cytec Industries, Incorporated, West Paterson, N.J.); 574.50 g isooctyl acrylate (3M Company, St Paul, Minn.); 0.61 g of VAZO 52 (2,2′-azo-di(2,4-dimethylvaleronitrile), E. I. du Pont de Nemours and Company, Wilmington, Del.); and 0.61 g of VAZO 88 (1,1-azo-bis(cyclohexanecarbonitrile), E. I. du Pont de Nemours and Company, Wilmington, Del.). An aqueous phase was made by mixing the following components in a 2000 mL container: 300 g deionized water; 0.0045 g hydroquinone (Eastman Chemical Company, Kingsport, Tenn.); 0.22 g disodium phosphate; 4.80 g Hitenol BC-1025 (polyoxyethylene alkylphenyl ether, 25% solids solution in water, DKS International, a subsidiary of Dai-ichi Kogyo Company, Limited, Kyoto, Japan); 10.65 g STEPANOL AM-V (ammonium lauryl sulfate, 28% solids solution, Stepan Company, Chicago, Ill.); 1.60 g NOIGEN RN-20 (polyoxyethylene alkylphenyl propenyl ether, 25% aqueous solution, DKS international); 0.61 g CYANAMER N-300 (polyacrylamide, 1% aqueous solution, Kemira Water Solutions, Incorporated, Bartow, Fla.); 81.95 g CARBOTAC 26222 (an acrylic latex binder, 51% solids, Lubrizol Corporation, Brecksville, Oh.). The monomer solution was poured into the container with the aqueous phase and mixed with a mechanical stirrer at 500 rpm for 3 minutes. The mixture was then homogenized using a Gifford-Wood homomixer at 2000 rpm for 10 minutes. The homogenized dispersion was poured into a 2-liter resin flask equipped with a thermometer, mechanical stirrer and nitrogen inlet tube. The homogenized solution was stirred at 400 to 500 rpm under a nitrogen blanket, heated to 60 C for 2 hours, then raised to and maintained at 75 C for 4 hours, and then cooled and filtered through cheesecloth to provide a ca. 61% solids aqueous dispersion of a microsphere adhesive.

### Adhesive Type 1 Preparation

To a glass jar were added FB49, various amounts of MSA, and PZ. The total combined wet weight of FB49 and MSA was 20 g. Prior to addition, the pH value of FB49 was adjusted to 6.8-6.9 with a 5 wt % aqueous ammonium solution. The dry weight amount of PZ crosslinker employed was calculated based on the dry weight of FB49. For example, for 20 g of a 95:5/FB49:MSA (wet weight ratio) composition and a 0.03% crosslinker level, 0.0032 g of PZ (dry weight) was used. Crosslinker solutions were used within 3 hours of their preparation. The jar was sealed and placed on a roller for approximately 30 minutes at room temperature to give an aqueous mixture designated generally as “Adhesive Type 1”. The % of the MSA component shown in the tables below is based on the combined dry weight of the FB49 and MSA components.

### Adhesive Type 2 Preparation

Samples of Adhesive Type 2 were prepared in the same manner as Adhesive Type 1 with the following modification. IR401 was used in place of MSA. The % of the IR401 component shown in the tables below is based on the combined dry weight of the FB49 and IR401 components.

### Control Examples

Control examples were prepared using pH adjusted (as described in “Adhesive Type 1 Preparation” above) FB49 with various levels of PZ.

### Protective Film Preparation

Protective films were prepared by knife coating the adhesives onto the primed side of a film backing using a 0.002 inch (0.051 mm) gap above the film, followed by drying at 65 C for 15 minutes in a forced air oven to give a tape construction having a dried adhesive thickness of 0.0007 inches (17.8 micrometers). The film backing had a 3 layer structure with a total thickness of 0.0036 inches (91.4 micrometers) and a thickness ratio of 25:50:25 for the top, middle, and bottom layers respectively. The top and bottom layers were low density polyethylene, and the middle layer was a blend of high density polyethylene, low density polyethylene, and a blend of low density polyethylene and titanium dioxide (TiO2) (30:70/w:w) in a ratio of 20:62:18 (w:w:w). One side of the backing was treated with an antiblocking agent (diatomaceous earth) and the other was corona treated (air) prior to applying a 0.011 inch (2.8 micrometers) thick layer of primer, such as those commercially available under the trade designations “SYNTHEBOND E2075” from Momentive Specialty Chemicals, Inc., South Carolina, USA and “CARBOTAC 26222” from The Lubrizol Corporation, Ohio, USA.

### Test Results

TABLE 1

| | 304 A Substrate | | | | | | | |
|---|---|---|---|---|---|---|---|---|
| | 1 Hour at Room Temperature | | | | 48 Hours at 150 F./80% RH | | | |
| Protective | Peel | Peel | | | Peel | Peel | | |
| Film | (oz/in) | (N/cm) | Stain | Residue | (oz/in) | (N/cm) | Stain | Residue |
| Nitto H3 | 7.2 | 0.79 | 0 | 0 | 16 | 1.75 | 0 | 0 |
| Nitto H5 | 16.6 | 1.82 | 0 | 0 | 21.4 | 2.34 | 0 | 0 |

TABLE 2

| | 304 P Substrate | | | | | | | |
|---|---|---|---|---|---|---|---|---|
| | 1 Hour at Room Temperature | | | | 48 Hours at 150 F./80% RH | | | |
| Protective | Peel | Peel | | | Peel | Peel | | |
| Film | (oz/in) | (N/cm) | Stain | Residue | (oz/in) | (N/cm) | Stain | Residue |
| Nitto H3 | 7.2 | 0.79 | 0 | 0 | 14.2 | 1.55 | 0 | 0 |
| Nitto H5 | 14.2 | 1.55 | 0 | 0 | 20.2 | 2.21 | 0 | 0 |

TABLE 3

| | | 304 A Substrate | | | | | | | |
|---|---|---|---|---|---|---|---|---|---|
| | | 1 Hour at Room Temperature | | | | 48 Hours at 150 F./80% RH | | | |
| Control | % | Peel | Peel | | | Peel | Peel | | |
| Ex. | PZ | (oz/in) | (N/cm) | Stain | Residue | (oz/in) | (N/cm) | Stain | Residue |
| 1 | 0 | 17.1 | 1.87 | 0 | 0 | 29.5 | 3.23 | 0 | 1 |
| 2 | 0.03 | 13.1 | 1.43 | 0 | 0 | 19.7 | 2.15 | 0 | 0 |
| 3 | 0.06 | 11.3 | 1.24 | 0 | 0 | 20.5 | 2.24 | 1 | 0 |
| 4 | 0.09 | 11.6 | 1.27 | 0 | 0 | 18.8 | 2.06 | 0.5 | 0 |
| 5 | 0.15 | 18.7 | 2.05 | 0 | 0 | 20.7 | 2.26 | 0 | 0 |

TABLE 4

| | | 304 P Substrate | | | | | | | |
|---|---|---|---|---|---|---|---|---|---|
| | | 1 Hour at Room Temperature | | | | 48 Hours at 150 F./80% RH | | | |
| Control | % | Peel | Peel | | | Peel | Peel | | |
| Ex. | PZ | (oz/in) | (N/cm) | Stain | Residue | (oz/in) | (N/cm) | Stain | Residue |
| 1 | 0 | 17.3 | 1.89 | 0 | 0 | 33.3 | 3.64 | 0 | 1 |
| 2 | 0.03 | 14.8 | 1.62 | 0 | 0 | 35.8 | 3.92 | 1 | 0 |
| 3 | 0.06 | 12.5 | 1.37 | 0 | 0 | 28.6 | 3.13 | 1 | 0 |
| 4 | 0.09 | 11.8 | 1.29 | 0 | 0 | 25.9 | 2.83 | 0 | 0 |
| 5 | 0.15 | 12.0 | 1.31 | 0 | 0 | 31.0 | 3.39 | 0 | 0 |

TABLE 5

| | | | 304 A Substrate | | | | | | | |
|---|---|---|---|---|---|---|---|---|---|---|
| | | | 1 Hour at Room Temperature | | | | 48 Hours at 150 F./80% RH | | | |
| | % | % | Peel | Peel | | | Peel | Peel | | |
| Ex | MSA | PZ | (oz/in) | (N/cm) | Stain | Residue | (oz/in) | (N/cm ) | Stain | Residue |
| 1a | 5.4 | 0.03 | 11.4 | 1.25 | 0 | 0 | 17.9 | 1.96 | 0 | 0 |
| 2a | 5.4 | 0.06 | 11.0 | 1.20 | 0 | 0 | 15.6 | 1.71 | 0 | 0 |
| 3a | 5.4 | 0.09 | 11.9 | 1.30 | 0 | 0 | 18.9 | 2.07 | 0 | 0 |
| 4a | 10.8 | 0.03 | 11.6 | 1.27 | 0 | 0 | 16.6 | 1.82 | 0 | 0 |
| 5a | 10.8 | 0.06 | 9.5 | 1.04 | 0 | 0 | 16.2 | 1.77 | 0 | 0 |
| 6a | 10.8 | 0.09 | 10.0 | 1.09 | 0 | 0 | 13.7 | 1.50 | 0 | 0 |
| 7a | 13.5 | 0.09 | 11.1 | 1.21 | 0 | 0 | 14.6 | 1.60 | 0 | 0 |
| 8a | 16.1 | 0.03 | 11.9 | 1.30 | 0 | 0 | 18.7 | 2.05 | 0 | 0 |
| 9a | 16.1 | 0.06 | 9.7 | 1.06 | 0 | 0 | 14.4 | 1.58 | 0 | 0 |
| 10a | 16.1 | 0.09 | 8.2 | 0.90 | 0 | 0 | 13.6 | 1.49 | 0 | 0 |
| 11a | 21.4 | 0.03 | 5.7 | 0.62 | 0 | 0 | 18.6 | 2.03 | 0 | 0 |
| 12a | 21.4 | 0.06 | 10.1 | 1.10 | 0 | 0 | 17.3 | 1.89 | 0 | 0 |
| 13a | 21.4 | 0.09 | 8.9 | 0.97 | 0 | 0 | 12.9 | 1.41 | 0 | 0 |
| 14a | 26.6 | 0.03 | 11.2 | 1.23 | 0 | 0 | 24.6 | 2.69 | 1 | 0 |
| 15a | 26.6 | 0.09 | 9.7 | 1.06 | 0 | 0 | 11.3 | 1.24 | 0 | 0 |
| 16a | 26.6 | 0.15 | 8.5 | 0.93 | 0 | 0 | 10.7 | 1.17 | 0 | 0 |
| 17a | 39.5 | 0.09 | 10.7 | 1.17 | 0 | 0 | 13.1 | 1.43 | 0 | 0 |
| 18a | 52.1 | 0.09 | 9.5 | 1.04 | 0 | 0 | 11.9 | 1.30 | 0 | 0 |
| 19a | 76.6 | 0.09 | 10.3 | 1.13 | 0 | 0 | 2.4 | 0.26 | 0 | 0 |
| 20a | 100 | 0.00 | 8.0 | 0.88 | 0 | 0 | 8.6 | 0.94 | 0 | 0 |

TABLE 6

| | | | 304 P Substrate | | | | | | | |
|---|---|---|---|---|---|---|---|---|---|---|
| | | | 1 Hour at Room Temperature | | | | 48 Hours at 150 F./80% RH | | | |
| | % | % | Peel | Peel | | | Peel | Peel | | |
| Ex | MSA | PZ | (oz/in) | (N/cm) | Stain | Residue | (oz/in) | (N/cm) | Stain | Residue |
| 1b | 5.4 | 0.03 | 12.0 | 1.31 | 0 | 0 | 15.1 | 1.65 | 0 | 0 |
| 2b | 5.4 | 0.06 | 10.4 | 1.14 | 0 | 0 | 22.4 | 2.45 | 0 | 0 |
| 3b | 5.4 | 0.09 | 12.7 | 1.39 | 0 | 0 | 24.0 | 2.63 | 1 | 0 |
| 4b | 10.8 | 0.03 | 12.3 | 1.35 | 0 | 0 | 21.2 | 2.32 | 0 | 0 |
| 5b | 10.8 | 0.06 | 13.2 | 1.44 | 0 | 0 | 24.5 | 2.68 | 0 | 0 |
| 6b | 10.8 | 0.09 | 9.7 | 1.06 | 0 | 0 | 15.6 | 1.71 | 0 | 0 |
| 7b | 13.5 | 0.09 | 10.3 | 1.13 | 0 | 0 | 16.5 | 1.80 | 1 | 0 |
| 8b | 16.1 | 0.03 | 12.3 | 1.35 | 0 | 0 | 27.2 | 2.98 | 0 | 0 |
| 9b | 16.1 | 0.06 | 9.2 | 1.01 | 0 | 0 | 20.5 | 2.24 | 0 | 0 |
| 10b | 16.1 | 0.09 | 7.6 | 0.83 | 0 | 0 | 16.6 | 1.82 | 0 | 0 |
| 11b | 21.4 | 0.03 | 11.7 | 1.28 | 0 | 0 | 24.9 | 2.72 | 0 | 0 |
| 12b | 21.4 | 0.06 | 10.5 | 1.15 | 0 | 0 | 18.7 | 2.05 | 0 | 0 |
| 13b | 21.4 | 0.09 | 10.4 | 1.14 | 0 | 0 | 18.0 | 1.97 | 0 | 0 |
| 14b | 26.6 | 0.03 | 10.5 | 1.15 | 0 | 0 | 18.9 | 2.07 | 1 | 0 |
| 15b | 26.6 | 0.09 | 10.8 | 1.18 | 0 | 0 | 14.9 | 1.63 | 0 | 0 |
| 16b | 26.6 | 0.15 | 10.2 | 1.12 | 0 | 0 | 12.9 | 1.41 | 0 | 0 |
| 17b | 39.5 | 0.09 | 9.8 | 1.07 | 0 | 0 | 17.2 | 1.88 | 0 | 0 |
| 18b | 52.1 | 0.09 | 10.5 | 1.15 | 0 | 0 | 14.0 | 1.53 | 0 | 0 |
| 19b | 76.6 | 0.09 | 9.0 | 0.98 | 0 | 0 | 2.7 | 0.30 | 0 | 0 |
| 20b | 100 | 0.00 | 7.2 | 0.79 | 0 | 0 | 12.6 | 1.38 | 0 | 0 |

TABLE 7

| | | | 304 A Substrate | | | | | | | |
|---|---|---|---|---|---|---|---|---|---|---|
| | | | 1 Hour at Room Temperature | | | | 48 Hours at 150 F./80% RH | | | |
| | % | % | Peel | Peel | | | Peel | Peel | | |
| Ex | IR401 | PZ | (oz/in) | (N/cm) | Stain | Residue | (oz/in) | (N/cm) | Stain | Residue |
| 21a | 5.6 | 0.03 | 12.4 | 1.36 | 0 | 0 | 22.2 | 2.43 | 0 | 0 |
| 22a | 5.6 | 0.06 | 12.7 | 1.39 | 0 | 0 | 21.5 | 2.35 | 0 | 0 |
| 23a | 5.6 | 0.09 | 11.7 | 1.28 | 0 | 0 | 15.6 | 1.71 | 0 | 0 |
| 24a | 11.1 | 0.03 | 10.1 | 1.10 | 0 | 0 | 17.0 | 1.86 | 0 | 0 |
| 25a | 11.1 | 0.03 | 12.7 | 1.39 | 0 | 0 | 23.2 | 2.54 | 0 | 0 |
| 26a | 11.1 | 0.06 | 9.8 | 1.07 | 0 | 0 | 16.8 | 1.84 | 0 | 0 |
| 27a | 11.1 | 0.06 | 9.9 | 1.08 | 0 | 0 | 19.5 | 2.13 | 0 | 0 |
| 28a | 11.1 | 0.09 | 9.2 | 1.01 | 0 | 0 | 18.0 | 1.97 | 0 | 0 |
| 29a | 11.1 | 0.09 | 12.4 | 1.36 | 0 | 0 | 18.3 | 2.00 | 1 | 0 |
| 30a | 16.6 | 0.03 | 11.7 | 1.28 | 0 | 0 | 18.8 | 2.06 | 0 | 0 |
| 31a | 16.6 | 0.06 | 9.8 | 1.07 | 0 | 0 | 16.5 | 1.80 | 0 | 0 |
| 32a | 16.6 | 0.09 | 8.7 | 0.95 | 0 | 0 | 17.4 | 1.90 | 0 | 0 |
| 33a | 22.0 | 0.03 | 10.0 | 1.09 | 0 | 0 | 23.7 | 2.59 | 0 | 0 |
| 34a | 22.0 | 0.06 | 8.9 | 0.97 | 0 | 0 | 19.0 | 2.08 | 0 | 0 |
| 35a | 22.0 | 0.09 | 8.7 | 0.95 | 0 | 0 | 20.6 | 2.25 | 0 | 0 |
| 36a | 27.3 | 0.09 | 10.5 | 1.15 | 0 | 0 | 26.8 | 2.93 | 0 | 0 |
| 37a | 52.9 | 0.09 | 6.4 | 0.70 | 0 | 0 | 27.2 | 2.98 | 1 | 0 |
| 38a | 77.1 | 0.09 | 5.0 | 0.55 | 0 | 0 | 25.4 | 2.78 | 0 | 0 |
| 39a | 100 | 0.0 | 1.2 | 0.13 | 0 | 0 | 3.2 | 0.35 | 0 | 6 |

TABLE 8

| | | | 304 P Substrate | | | | | | | |
|---|---|---|---|---|---|---|---|---|---|---|
| | | | 1 Hour at Room Temperature | | | | 48 Hours at 150 F./80% RH | | | |
| | % | % | Peel | Peel | | | Peel | Peel | | |
| Ex | IR401 | PZ | (oz/in) | (N/cm) | Stain | Residue | (oz/in) | (N/cm) | Stain | Residue |
| 21b | 5.6 | 0.03 | 15.5 | 1.70 | 0 | 0 | 41.2 | 4.51 | 1 | 0 |
| 22b | 5.6 | 0.06 | 13.1 | 1.43 | 0 | 0 | 36.7 | 4.01 | 1 | 0 |
| 23b | 5.6 | 0.09 | 11.3 | 1.24 | 0 | 0 | 28.5 | 3.12 | 0.5 | 0 |
| 24b | 11.1 | 0.03 | 13.7 | 1.50 | 0 | 0 | 21.3 | 2.33 | 0 | 0 |
| 25b | 11.1 | 0.03 | 14.3 | 1.56 | 0 | 0 | 31.6 | 3.46 | 1 | 0 |
| 26b | 11.1 | 0.06 | 9.0 | 0.98 | 0 | 0 | 22.1 | 2.42 | 0 | 0 |
| 27b | 11.1 | 0.06 | 12.0 | 1.31 | 0 | 0 | 26.8 | 2.93 | 0.5 | 0 |
| 28b | 11.1 | 0.09 | 8.6 | 0.94 | 0 | 0 | 19.7 | 2.15 | 0 | 0 |
| 29b | 11.1 | 0.09 | 11.7 | 1.28 | 0 | 0 | 24.9 | 2.72 | 1 | 0 |
| 30b | 16.6 | 0.03 | 11.7 | 1.28 | 0 | 0 | 27.9 | 3.05 | 0 | 0 |
| 31b | 16.6 | 0.06 | 10.3 | 1.13 | 0 | 0 | 25.1 | 2.75 | 0 | 0 |
| 32b | 16.6 | 0.09 | 9.1 | 1.00 | 0 | 0 | 24.4 | 2.67 | 0 | 0 |
| 33b | 22.0 | 0.03 | 14.2 | 1.55 | 0 | 0 | 32.4 | 3.54 | 1 | 0 |
| 34b | 22.0 | 0.06 | 8.6 | 0.94 | 0 | 0 | 26.7 | 2.92 | 1 | 0 |
| 35b | 22.0 | 0.09 | 7.6 | 0.83 | 0 | 0 | 23.2 | 2.54 | 0 | 0 |
| 36b | 27.3 | 0.09 | 9.2 | 1.01 | 0 | 0 | 38.5 | 4.21 | 1 | 0 |
| 37b | 52.9 | 0.09 | 8.0 | 0.88 | 0 | 0 | 68.4 | 7.48 | 2 | 5 |
| 38b | 77.1 | 0.09 | 5.2 | 0.57 | 0 | 0 | 36.6 | 4.00 | 3 | 5 |
| 39b | 100 | 0.0 | 0.8 | 0.09 | 0 | 0 | 2.2 | 0.24 | 1 | 4 |

TABLE 9

| | % | % | % | Pressure (MPa) | | | | | | | | |
|---|---|---|---|---|---|---|---|---|---|---|---|---|
| Ex. | PZ | MSA | IR401 | 0.2 | 0.4 | 0.6 | 0.8 | 0.9 | 1 | 1.2 | 1.3 | 1.4 |
| 20 | 0.00 | 100 | | F | F | F | F | | | | | |
| 19 | 0.09 | 76.6 | | F | F | F | F | | | | | |
| 18 | 0.09 | 52.1 | | P | F | P | P | F | F | | | |
| 17 | 0.09 | 39.5 | | P | F | P | F | P | F | | | |
| 15 | 0.09 | 26.6 | | F | P | P | F | P | F | | | |
| 12 | 0.06 | 21.4 | | P | P | P | P | P | F | | | |
| 9 | 0.06 | 16.1 | | F | F | P | F | F | F | | | |
| 5 | 0.06 | 10.8 | | | | P | F | F | F | F | | |
| 2 | 0.06 | 5.4 | | | | P | P | P | F | | | |
| 39 | 0.00 | | 100 | F | F | F | F | | | | | |
| 38 | 0.09 | | 77.1 | F | F | F | | | | | | |
| 37 | 0.09 | | 52.9 | F | F | F | | | | | | |
| 36 | 0.09 | | 27.3 | P | P | P | | P | P | P | F | F |
| 34 | 0.06 | | 22.0 | | | P | P | P | P | P | F | |
| 25 | 0.03 | | 11.1 | | | P | P | P | P | F | | |
| 27 | 0.06 | | 11.1 | | | P | P | F | F | | | |
| 28 | 0.09 | | 11.1 | | | P | P | F | P | F | | |
| 22 | 0.06 | | 5.6 | | | P | | | P | P | F | |

| | | | | | | |
|---|---|---|---|---|---|---|
| Nitto H-3 | F | F | F | F | F | |
| Nitto H-5 | P | P | P | P | P | F |

*If neither P or F is shown then the sample was not tested at that pressure.

1. An article comprising:
a) a protective film comprising a thermoplastic film having a first side and a second side, and a pressure sensitive adhesive composition adhesively attached to at least one of the first side or the second side of the thermoplastic film, wherein the pressure sensitive adhesive composition comprises a blend of:
i) an aqueous based pressure sensitive adhesive latex;
ii) a low adhesion additive; and
iii) a crosslinker; and
b) a metal substrate adhesively attached to a side of the pressure sensitive adhesive composition opposite the thermoplastic film.

2. The article of claim 1 wherein the low adhesion additive is selected from at least one of an acrylic emulsion, a particulate dispersion and a rubber emulsion.

3. The article of claim 1 wherein the aqueous based pressure sensitive adhesive latex comprises at least one acrylate polymer.

4. The article of claim 1 wherein the aqueous based pressure sensitive latex comprises a stabilizer selected from at least one of a cationic stabilizer, anionic stabilizer, a non-ionic stabilizer, and an amphoteric stabilizer.

5. The article of claim 2 wherein the rubber emulsion comprises a (poly)isoprene latex.

6. The article of any of claim 2 wherein the particulate dispersion comprises polymeric microspheres.

7. The article of claim 6 wherein the polymeric microspheres are elastomeric.

8. The article of claim 1 wherein the crosslinker is a polyaziridine.

9. The article of claim 1 wherein the thermoplastic film is a three layer polyethylene film wherein each layer comprises low density polyethylene.

10. The article of claim 9 wherein the middle layer comprises high density polyethylene.

11. The article of claim 1 wherein the metal substrate is stainless steel.

12. The article of the claim 1 wherein the pressure sensitive adhesive composition is substantially free of acrylic acid.

13. The article of claim 1 wherein the crosslinker comprises 0.03 wt % to 0.09 wt % based on the dry weight of the aqueous based pressure sensitive adhesive latex.

14. The article of claim 1 wherein the low adhesion additive comprises 5 wt % to 53 wt % of the total dry weight of components i) and ii).

15. A pressure sensitive adhesive composition comprising a blend of:
i) an aqueous based pressure sensitive adhesive latex;
ii) a low adhesion additive; and
iii) a crosslinker,
wherein the low adhesion additive comprises 5 wt % to 53 wt % of the total dry weight of components i) and ii).

16. The composition of claim 15 wherein the low adhesion additive is selected from at least one of a particulate dispersion and a rubber emulsion.

17. The composition of claim 16 wherein the aqueous based pressure sensitive adhesive latex comprises at least one acrylate polymer.

18. The composition of claim 15 wherein the aqueous based pressure sensitive adhesive latex comprises a stabilizer selected from at least one of a cationic stabilizer, anionic stabilizer, a non-ionic stabilizer, and an amphoteric stabilizer.

19. The composition of claim 15 wherein the rubber emulsion comprises a (poly)isoprene latex.

20. The composition of claim 15 wherein the particulate dispersion comprises polymeric microspheres.

21-26. (canceled)
